(19) United States
(12) Patent Application Publication
(10) Pub. No.: US 2009/0150241 A1
(43) Pub. Date: Jun. 11, 2009

(54) CUSTOMIZABLE FOOD KIT WITH CUSTOMIZED MULTIMEDIA INSTRUCTIONS

(76) Inventor: Laurent Laboise, Toronto (CA)

Correspondence Address: Deeth Williams Wall LLP;Attn: James Kosa, Suite 400, 150 York Street, Toronto, ON, M5H 3S5, CA

(21) Appl. No.: 12/267,318

(22) Filed: Nov. 7, 2008

Related U.S. Application Data
(60) Provisional application No. 60/986,115, filed on Nov. 7, 2007.

(51) Int. Cl. G06Q 50/00; G06Q 30/00

(52) U.S. Cl. 705/14; 705/26; 705/15

(57) ABSTRACT

The invention relates to a customizable meal kit having at least one customizable ingredient selected by a customer, and a set of customized instructions that may be automatically created and provided to the customer along with the meal kit. The customized instructions may be multimedia or video instructions which in modules corresponding to the customizations available to the customer.

### FIELD OF THE INVENTION

The application relates to food kits including instructions, and methods of manufacture and sale of these food kits.

### BACKGROUND OF THE INVENTION

Meal kits typically have ingredients and instructions on how to prepare the ingredients into a meal. Consumers typically purchase such a kit because it is convenient, and with the instructions may be easier to prepare a meal than preparing it from scratch. Such kits have many benefits. Often they may be faster to prepare than a conventional meal, and may have less waste or leftover materials. For particularly complicated meals, they may be more economical, as the kit producer is able to prepare the ingredients for many kits at a per kit cost less than the amount a consumer would pay if the consumer purchased all of the ingredients individually.

Some meal kits have some or all of the ingredients prepared in advance of the consumer purchasing the kit. The ingredients may be chopped, powdered or sliced, measured to the right proportions, or cooked or treated in advance, to make it easier and faster for the consumer to prepare the meal.

The problem with such kits is that typically the consumer is not able to customize their contents. For example, a consumer may be allergic to nuts, and therefore would like to order a meal kit without nuts. A consumer may wish to prepare a vegan meal, or have other dietary restrictions or preferences. A consumer may wish to subtly change the flavour or spiciness of a particular meal. Most producers of meal kits do not allow for customization, as customization creates inconsistencies with the meal kit's instructions.

Producers that offer meal kits that do not allow for customization may be limited in the type of marketing they can use. They may be limited to generic marketing campaigns that are broad in scope and are unable to use targeted marketing tailored to the custom preferences of a consumer.

Many meal kits come with written instructions that provide limited guidance on how to prepare the ingredients into a meal. For example, the instructions of a meal kit may call for the chopping of an ingredient, but do not show how best to chop that ingredient. An inexperienced cook may encounter difficulties in preparing the meal kit as they may lack some of the basic skills to prepare the ingredients.

### SUMMARY OF THE INVENTION

The invention relates to a customized meal kit with customized instructions.

The invention also relates to the customized meal kit described above, wherein the customized instructions comprise multimedia instructions.

The invention also relates to the customized meal kit described above, wherein the customized instructions are prepared automatically by an ordering system.

The invention also relates to a system for the preparation of customized instructions on the basis of an order from a customer for a customized meal kit, wherein the system automatically compiles customized instructions for the customized meal kit.

The invention also relates to a system of using custom information obtained from a customer's previous orders to tailor marketing to that customer.

### BRIEF DESCRIPTION OF THE DRAWINGS

Some embodiments of the invention are detailed in drawings as follows:

FIG. 1 shows a schematic of a meal kit according to the invention.

FIG. 2 shows a process map of a new user interacting with a website to order a customized meal kit with customized instructions according to the invention.

FIG. 3 shows a process map of a returning user interacting with a website to order a customized meal kit with customized instructions according to the invention.

FIG. 4 shows a schematic of a product page of a website dedicated to the sale of customized meal kits according to the invention.

FIG. 5 shows a schematic of a profile page of a website dedicated to the sale of customized meal kits according to the invention.

FIG. 6 shows a schematic of a chef page of a website dedicated to the sale of customized meal kits according to the invention.

### DETAILED DESCRIPTION OF THE INVENTION

In one embodiment, a meal kit comprises customizable ingredients and customizable instructions. The customizable ingredients may be raw food items or food items in various states of preparedness. A customer may order the kit online or by telephone, and specify the customizable ingredients to be included. A customization system may automatically create the customized instructions on the basis of the customized ingredients in the customized meal kit.

In one embodiment, the customizable instructions may be interactive multimedia instructions, enabled with video or animated portions. The interactive multimedia instructions may be broken down into modular instruction components. The customizable instructions may be for preparing restaurant/professional quality meals.

The customizable ingredients, articles and instructions may be packed into a single meal kit. The ingredients may be pre-measured, washed, and individually vacuum packed. They may be then assembled and further packed into an insulating envelope, or another container with similar properties, with an ice pack to maintain the freshness of the food during transportation. The instructions included in the kit may be in the form of a prerecorded modular video of a professional chef preparing the meal from the same pre-measured ingredients that may be included in the kit. The chef in the video prepares a meal from the ingredients included in the kit in a step-by-step manner, which allows the consumer to follow the information presented by the chef in real time, while they prepare their meal. The modular video instructions may be accessed via a website using a unique identifiable code found in or on the kit and may be available in either streaming or downloadable form.

The method of providing the customizable meal kit starts with the consumer visiting a website where the meal kits may be available for purchase. When a consumer accesses the website they may be able to browse through various meal courses or meal kits. The consumer may select various courses to create a meal kit. This is the first level of customization. Once they decide on a combination of courses they would like to purchase, they will then be presented with a number of options to further customize the meal kit. This is the second stage of customization. At this stage the consumer may choose a number of options, such as the number of servings, whether to exclude or replace certain ingredients in accordance with their liking, and whether to purchase or rent certain standard equipment that may be required to prepare the meal. Once the consumer has selected a meal kit and went through the initial steps of customization, they may then proceed to purchase the product by clicking on a ‘buy’ button on the website. At this stage they may be presented with additional purchase options. They may select either same day or next day delivery and will receive the unique identifiable code for accessing the modular video cooking instructions via the website. In the final purchasing step the consumer may enter their billing address and payment information, and may confirm the product purchase.

While the user is actively customizing their meal kit, the website may concurrently generate unique modular video instructions for preparing the meal kit from a stock of modular video components. This is yet another level of customization. Each of the consumer's customization decisions (i.e. the courses, ingredients and number of servings selected), may be factored into the production of the video instructions. The instructions may be created from a stock of standard videos. Each video element may correspond to a particular customization selected by the customer. When the customer places their order, the system may string together only the relevant video elements to create a comprehensive set of customized instructions. The customizations to the video may be based not only on the added, removed or substituted ingredients, but also on the skill level of the customer and other factors that may be unique to that customer.

Once the product has been purchased, another level of customization begins. A database using software stored on computer memory may be maintained to track each purchase made by a specific consumer. This information may be used for at least two purposes. Firstly, the information may be used to tailor the meal courses and ingredients presented to the consumer the next time the access the Website. Secondly, the information may be cross-referenced with the consumer's current purchase to further tailor the video instruction included with the meal kit. The instruction may be customized based on the consumer's initial selection of courses and ingredients and their history of past purchases. For example, if a customer may be purchased the same meal kit before, the instructions may be customized to account for the consumer's previous experience (i.e. the instruction may be directed towards a higher skill level). Once it is determined what instructional content will be included in the kit a unique video and unique identifying code may be generated. The unique identifying code may be included in or on the meal kit package, or otherwise delivered to the customer. When the consumer receives the code, they may enter it on the website to stream or download the custom modular video cooking instructions. Alternatively, the customized instructions may be stored on a storage medium, such as a DVD or other storage device, and sent to the customer, preferably along with the meal kit.

The software may include executable code stored in a memory for execution by a processor. A memory may include any static, transient or dynamic memory or storage medium, including without limitation read-only memory (ROM) or programmable ROM, random access registers memory (RAM), transient storage in registers or electrical, magnetic, quantum, optical or electronic storage media. A process includes any device or set of devices, howsoever embodied, whether distributed or operating in a single location, that is designed to or has the effect of carrying out a set of instructions, but excludes an individual or person. A system implemented in accordance with the present invention may comprise a computer system having memory and a processor to execute the code. The system may also comprise a server and client structure, where the user is writing on a client terminal, including a wireless handheld device or cell phone, and the method is performed on a server.

The consumer may then simply follow their custom, step-by-step video instructions to prepare the customized meal. The consumer may become a member of the website to make it easier for the website to track their preferences, past purchases, and other particulars. When a consumer becomes a member, the likes and dislikes of the consumer may be automatically profiled.

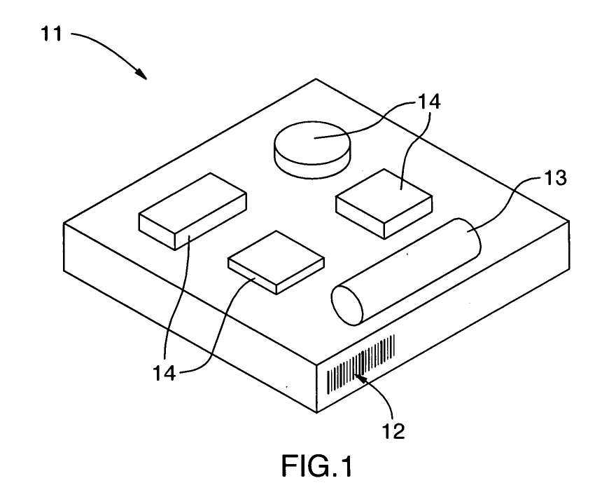

FIG. 1 shows a meal kit, comprising a thermo economical envelope 11, enclosing a plurality of pre-measured, washed, and individually vacuum packed ingredients 14 and an ice pack 13. The individually vacuum packed ingredients 14 may be selected by the purchaser of the kit on the product page of the manufacturer's website and may make up all of the ingredients required to cook the courses of an advertised meal. An ice pack 13 or other temperature regulator may be enclosed in the kit to ensure that the ingredients 14 arrive at the consumer's home in a fresh state. A unique identifying code 12 may either be enclosed in or displayed upon thermo economical envelope 11 or may be sent to the consumer via e-mail following purchase of the meal kit from the website.

In one embodiment, the meal kit further comprises articles such as utensils, cutting boards, or other tools that may be useful in the preparation of the ingredients.

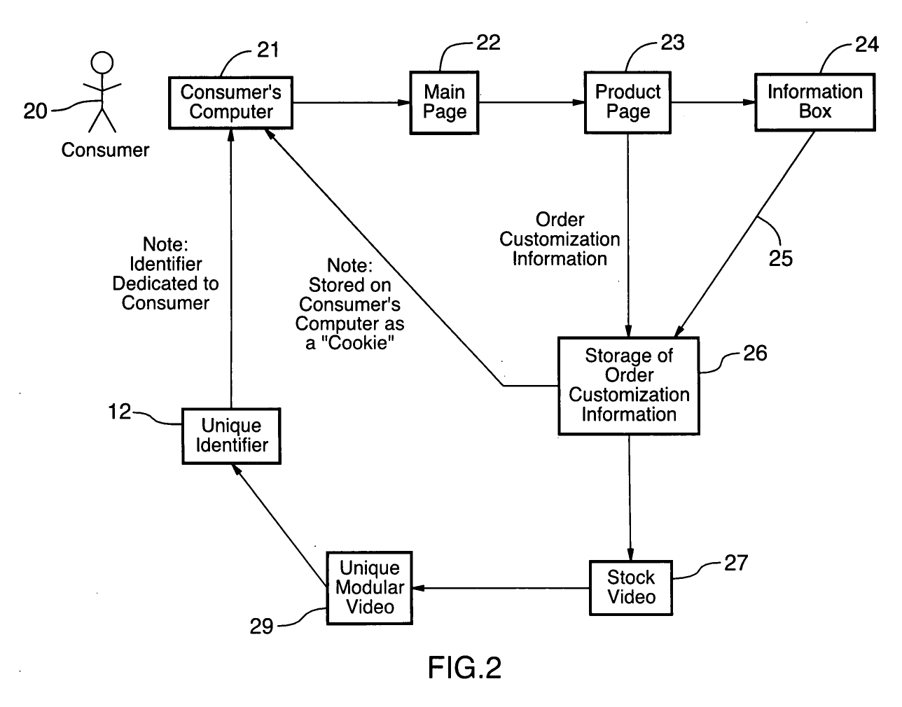

FIG. 2 shows a process map describing a method of providing a customizable meal kit to a new consumer 20. In this embodiment of the invention, a consumer 20 may access a website to order a customized food kit. From the main page 22 of the website, the consumer may navigate to a product page 23 which depicts the meal kits and their options for customization. The consumer may select various meal kits from the product page 23. The meal kit may comprise a course of a meal, or a set or courses. When a meal kit is selected, an information box 24 may appear to provide customization options. When a meal course is selected and customized, this information is stored by the website as order customization information 25. In the information box, the consumer may further customize features of the meal course, including the ingredients, delivery time and cooking skill level. Any customizations that are made may be stored as order customization information 25.

The stored order customization information 26 may be updated in real-time by the website as the consumer makes customization decisions. The website may use this information to select and edit stored modular video components 27 of cooking instructions to create a unique modular video 29 providing cooking instructions that relate to the consumer's personally customized meal kit.

When the consumer purchases the meal kit, a unique identifying code 12 or key may be generated. The unique identifying code 12 is used by the consumer 20 to access the unique modular video 29 instructions from the program page of the website. The unique identifying code 12 may be labeled onto the thermo economical envelope 11 or may be sent to the consumer 20 via e-mail with a receipt following purchase.

In this embodiment of the invention, the order customization information 25 is stored on the website after the customers purchase. The information is used to generate a “cookie” or other tracking file, stored on the consumer's computer 21. Alternatively, non residual tracking systems may be used to track user preferences, such as IP logging or other methods know in the art. The next time the consumer 20 accesses the main page 22 and product page 23, the pages may be customized to meet the consumer's preferences, which may be based on previously collected order customization information 25.

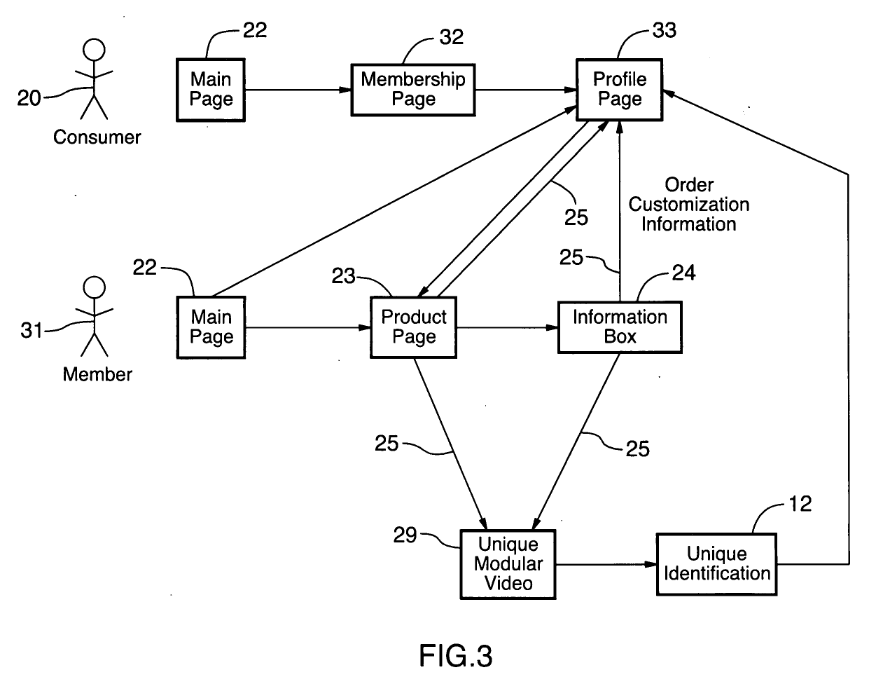

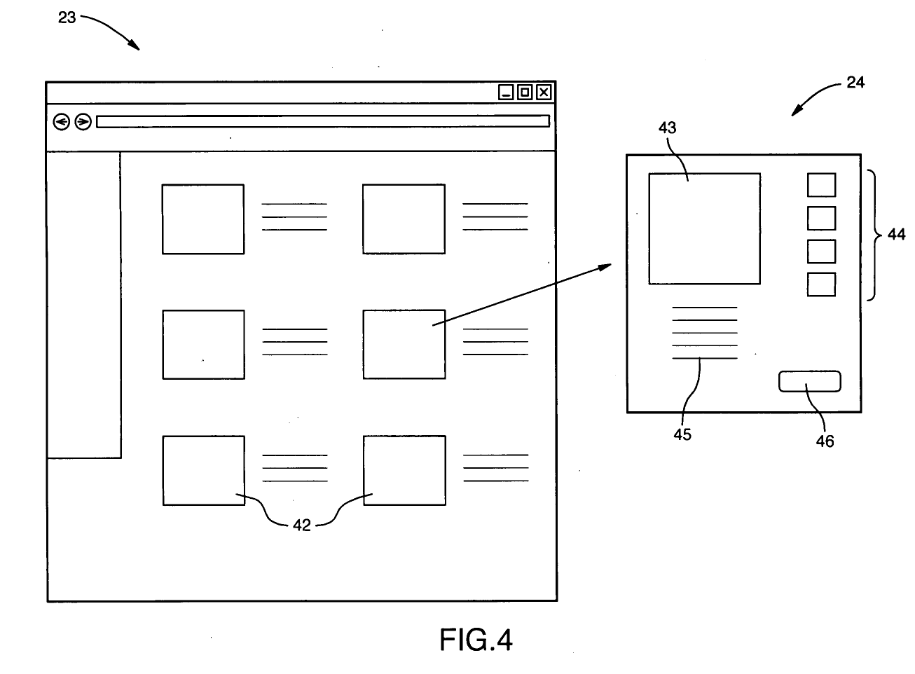

FIG. 3 shows a process map describing a method of providing a customizable meal kit to a previous consumer. In this embodiment of the invention a consumer 20 has the option to become a member of the website. They may become a member by signing up on the membership page 32, which may be accessed through the main page 22. When a consumer 20 signs up, they will enter standard personal information, such as their name and e-mail address, and food related information, such as any allergies they may have, their food preferences and cooking ability. This personal information may be used to create a unique profile page 33, an embodiment of which is shown in more detail in FIG. 4. The next time the consumer 20 accesses the main page of the website they may enter their membership code on the main page 22. The member 31 may then choose to order a customized meal kit through one of two methods. They may follow the process explained in FIG. 2, or may instead access their personal profile page 33. The profile page will display links to meal courses on the product page 23 that meet the consumer's preferences, as determined from the personal information entered at the time of signing up and from previously collected order customization information 25. When a consumer accesses a meal kit information box 24 through the profile page 33, the ingredient selection icons in the information box 24 will be automatically populated to account for the consumer's preferences, so that the consumer will not have to browse through customizations that they have already indicated that they have no interest in. For example, if the consumer is allergic to nuts, the customization system will not display a customization option that allows the user to add nuts to a meal kit.

The order customization information 25 from each subsequent purchase by the consumer may be used to update the profile information stored in the customization system on the website. When a member purchases a meal kit, the unique modular video 29 associated with the meal kit (created by the method described above) may be temporarily stored on their profile page 33 on the website, and within the customization system linked to the website. A unique identifying code 12 may also be sent to them with a receipt e-mail as described above, which allows them to access the unique modular video 29 through the website.

The website may have a main page 22, which may have a description of the customizable meal kit concept, and provide an option for members to log in. The main page may contain links to other pages, including a product page 23 and a membership page 33.

FIG. 4 shows one embodiment of a product page 23, which displays pictures of the meal courses offered for sale. When a consumer clicks on one of the pictures 42, an information box 24 may appear. The consumer's choice of the meal course may be stored on the website as order customization information 25. Within an information box there may be small icons 44 located to allow consumers to select ingredients to customize the meal kit to their liking. The ingredients selected by the consumer may be stored on the website as order customization information 25. The information box may also contain a video preview box 43, which allows the consumer to watch a brief preview of the instructional cooking video, and preferably other relevant information 45 including the portion size, preparation and cooking time and the required cooking skill level. The information box may also contain a button 46 to allow consumers to purchase the meal kit. When a consumer has finished all transactions and is ready to finalize payment, they may click the check out button and a billing page appears. The consumers billing information may be entered into billing box. When the consumer clicks the payment confirmation button, a unique identifying code 12 may be generated. The unique identifying code 12 may be used to link the consumer's purchase with the unique modular video 29 instructions created during the customization of the meal kit.

The website may have a membership page 32. In one embodiment, the membership page displays a personal information box that allows a consumer to enter their personal information. This box captures both standard personal information, such as name and e-mail address, and food related information, such as any allergies the consumer may have, the consumer's food preferences, and cooking ability. When a consumer completes these fields and clicks on a button a customized profile page 33 may be generated. Once the profile page 33 is generated the consumer may access the page on subsequent visits to the website through the main page 22.

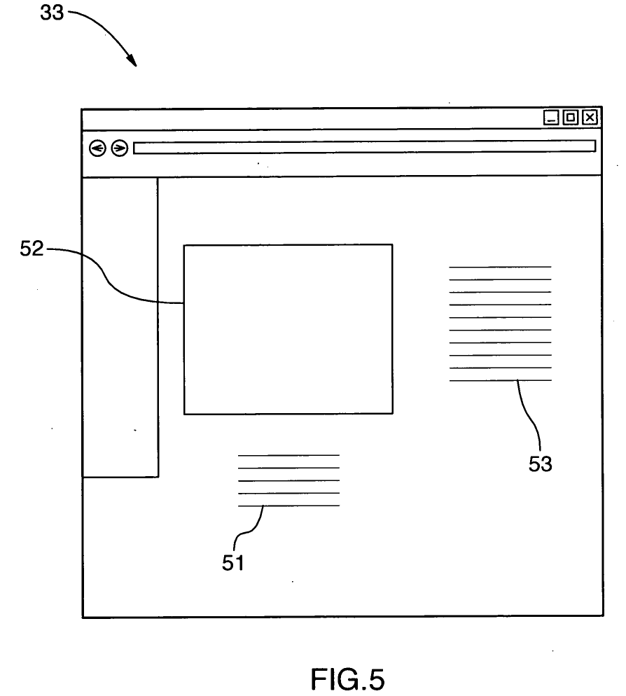

FIG. 5 shows one embodiment of the profile page 33. The profile page 33 may be customized based on the personal information the consumer provides when signing up for membership on the membership page 32 and may be continually updated based on order customization information 25 obtained during the consumer's purchases. The profile page 33 may have a box 52 which displays the unique modular video 29 instructions that relate to the customer's last meal kit purchase. The profile page may also contain links 53 to meal courses on the product page 23, which may be tailored to the consumer's preferences.

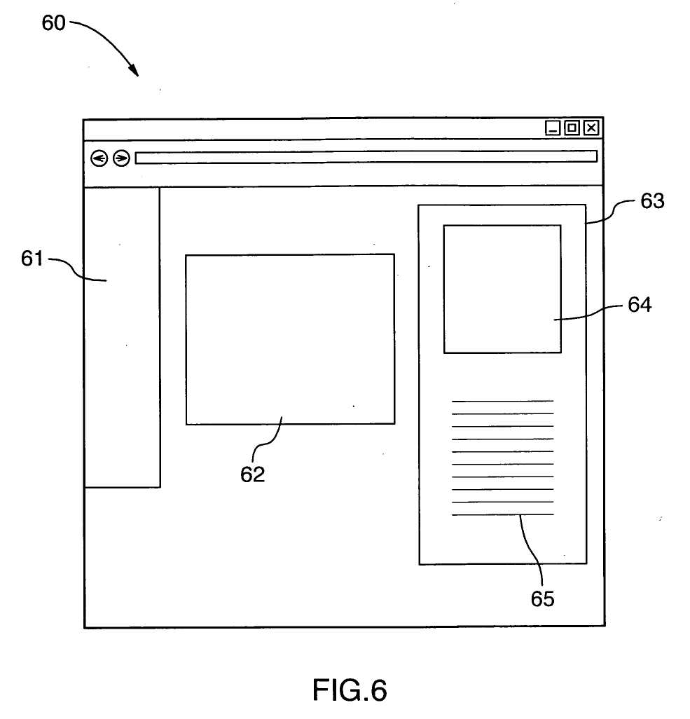

FIG. 6 shows one embodiment of a chef page 60 on the website. This page may display information about the professional chefs that appear in the instructional cooking videos, and may allow potential purchasers to review the instructional content before making a purchase. Potential purchasers of meal kits may navigate the menu box 61 to select a chef that they would like to learn about. Once a chef is selected a profile 65 and picture of the chef 64 may appear in the profile box 63. A brief clip of one of the chef's instructional videos may also appear in the video box 62.

What is claimed is:

1. A method of customizing a meal kit from customizable instructions and customizable ingredients comprising the steps of:
a. accessing meal kit order system online or by telephone;
b. browsing customizable meal courses or customizable meal kits;
c. selecting customizable meal courses, meal options and customizable ingredients to be included in the order;
d. generating customized instructions based on the customizable meal courses, the meal options and the customizable ingredients;
e. packing the customizable ingredients and the customized instructions into a meal kit; and
f. tracking customer preferences and storing on a computer memory to tailor marketing, video instructions and future meal offerings to the customer.

2. The method of claim 1 wherein the customized ingredients comprise raw food items or food items in various states preparedness.

3. The method of claim 1 wherein the customized instructions comprise multimedia instructions.

4. The method of claim 3 wherein the multimedia instructions are interactive multimedia instructions, enabled with video or animated portions.

5. The method of claim 3 wherein the multimedia instructions are in modular form.

6. The method of claim 1 wherein the customized instructions are prepared automatically by an ordering system.

7. A system for the preparation of customized instructions on the basis of an order from a customer for a customized meal kit comprising:
a. an online or telephone meal kit order interface, wherein the meal kit order interface permits browsing of customizable meal courses or customizable meal kits;
b. a selection module for selecting customizable meal courses, meal options and customizable ingredients to be included in the order, wherein customized instructions are generated based on the customizable meal courses, the meal options and the customizable ingredients;
c. a meal kit comprising the customized ingredients and the customized instructions; and
d. a computer memory to store customizations specific to a customer tracked using a database.

8. The system of claim 7 wherein the customized ingredients comprise raw food items or food items in various states preparedness.

9. The system of claim 7 wherein the customized instructions comprise multimedia instructions.

10. The method of claim 9 wherein the multimedia instructions are interactive multimedia instructions, enabled with video or animated portions.

11. The method of claim 9 wherein the multimedia instructions are in modular form.

12. The system of claim 7 wherein the system automatically compiles customized instructions for the customized meal kit.

13. The system of claim 7 wherein the system uses custom information obtained from a customer's previous orders to tailor marketing, video instructions and future meal offerings to the customer.
